(19) United States
(12) Patent Application Publication
(10) Pub. No.: US 2009/0058239 A1
(43) Pub. Date: Mar. 5, 2009

(54) AIR-GROUND TRANSPORT SYSTEM AMD METHOD FOR DELIVERING MULTI-TEMPERATURE GOODS

(75) Inventors: Ju-Chia Kuo, Chu Tung Town (TW); Jenn-Chyi Chung, Chu Tung Town (TW); Huo-Tu Huang, Chu Tung Town (TW)

Correspondence Address: VENABLE LLP, P.O. BOX 34385, WASHINGTON, DC, 20043-9998, US

(73) Assignee: Industrial Technology Research Institute, Hsin Chu Hsien (TW)

(21) Appl. No.: 11/961,016

(22) Filed: Dec. 20, 2007

(30) Foreign Application Priority Data
Aug. 30, 2007 (TW) 96132200

(51) Int. Cl. G06Q 50/00; A47J 47/14

(52) U.S. Cl. 312/236; 705/1

(57) ABSTRACT

An air-ground transport system for delivering multi-temperature goods, including a flight kitchen distribution center having at least a freezer, at least one in-flight meal service cart, and at least one cold plate, so that the prepared food can be placed on a meal-serving device to be stored inside the in-flight meal service cart equipped with at least one cold plate that keeps its cooling capacity inside the freezer; an airport facility including an aircraft having a temporary food storage and preparation area and one conveyer transferring the in-flight meal service cart to the temporary food storage and preparation area in the aircraft to be secured, with the cold plate still providing cooling energy, keeping fresh the food stored inside the in-flight meal service cart; and a transporter on which the in-flight meal service cart is loaded to be delivered to the airport facility. The present invention further includes an air-ground transport method for delivering multi-temperature goods, so as to ensure the quality and sanitation of the food and to deliver goods with multi-temperature requirements in a single attempt without refrigeration power. The present invention is particularly good at dealing with multi-temperature goods, such as foods with different temperatures. Not only can the present invention overcome concerns about refrigerating equipments and fuel consumption in relation to the conveyer and the aircraft, but it can also reduce the amount of dry ice required, preventing the dry ice from gasifying and from the subsequent air pollution and danger.

### BACKGROUND OF THE INVENTION

1. Field of the Invention

The present invention relates to a transport system, especially an air-ground transport system and method for delivering multi-temperature goods.

2. Description of the Related Art

Traditionally, in-flight meals are prepared and get ready in a flight kitchen center before being placed inside an in-flight meal service cart for fresh keeping purposes. However, because traditional in-flight meal service carts are made of plywood, they are short of thermal insulation structures and unable to keep food cold. In addition, when airplanes are in stand-by, which includes cleaning and other preparation work, there is no way for them to provide cooling energy, either. Therefore, whenever in-flight meals are prepared in the flight kitchen center, dry ice must be placed on the top portion of the in-flight meal service cart to keep the meals fresh during ground support operations. However, while the in-flight meal service cart requires dry ice to retain its desired temperature, it does not do a good job in terms of thermal insulation. Therefore, it is both ineffective and consumptive when using in-flight meal service carts to store meals. Worse still, with the low temperature of the dry ice, which usually goes down to approximately −79° C., and the instability of the temperature, food tends to suffer from frost damage or becomes frozen as a result of the very low temperature.

Usually, in-flight meal service carts must get to the airport two hours prior to take-off, during which dry ice is used to keep food cold. Once on board, the in-flight meal service cart will rely on the started airplane's refrigeration system for cooling energy. Traditionally, the refrigeration system in the airplane's temporary food storage and preparation area is either a centralized system or an individualized system. FIG. 1, for example, shows a centralized refrigeration system 1, in which cooling media (an anti-freezing liquid) are sent to a heat exchanger 3 by way of conduits. Each of the in-flight meal service carts 5 has an air vent 6, 7 in communication with the air conduits, with a fan 4 used to draw the air, via the air vent 6, from every single in-flight meal service cart 5 to the heat exchanger 3 for cooling purposes, followed by the sending back of the air to the inside of the in-flight meal service cart 5 through the air vent 7.

In an individualized refrigeration system, on the other hand, every single temporary food storage and preparation area on the airplane is reliant on individual air chillers for cooling energy. Each air chiller is in communication with an in-flight meal service cart in the temporary food storage and preparation area through an air circulation duct, within which an air-supply channel and an air-returned channel are provided and work in a way that air inside the in-flight meal service cart is drawn to the evaporator in the air chiller for cooling purposes through the air-returned channel before being sent back to the inside of the in-flight meal service cart through the air-supply channel, so that the inside of the in-flight meal service cart can be kept cold.

So, during long-haul flights, it is the refrigeration system (may it be a centralized one or an individualized one) that supplies cooling energy to the in-flight meal service cart to maintain the temperature inside the cart. A flight journey usually takes more than 10 hours (usually with a 14-hour-or-so interval between the first mealtime and the last mealtime), serving up to 2-3 meals. Not only does the first meal require the airplane to provide cooling energy to keep the food cold, but the second or the third meal also does, too. Since it is fuels that are converted into power to run the refrigeration system, the fuel consumption of a flight will increase as a result of the inefficiency and the weight of the refrigeration system.

### SUMMARY OF THE INVENTION

The objective of the present invention is to provide an air-ground transport system and method for delivering multi-temperature goods, so that airplanes can transport meals and goods with multi-temperature requirements in a single attempt, and the in-flight meal service carts can keep food fresh without excessive airplane fuel consumption.

To achieve the objective, the air-ground transport system for delivering multi-temperature goods according to the present invention includes a flight kitchen distribution center, a transporter, an airport facility and an aircraft. The flight kitchen distribution center is where food is prepared before being placed on meal-serving devices for being stored inside a thermal insulated and cold-keeping in-flight meal service cart, which is equipped with a cold plate that goes with the food temperature to keep the freshness and coolness of the food during delivery. The in-flight meal service cart is subsequently loaded onto the transporter to be delivered to the airport, with the transporter being a multi-temperature transport vehicle. The in-flight meal service cart is either directly delivered to the aircraft by the transporter en route the airport facility or unloaded from the transporter to the conveyer included in the airport facility, such as a loading vehicle, for being transferred to the temporary food storage and preparation area in the aircraft to be secured.

The transporter is loaded with a plurality of in-flight meal service carts, which store food and keep it fresh. Food with different temperature requirements is stored in in-flight meal service carts with corresponding temperatures, within which cold plates with corresponding temperatures are provided. The transporter delivers the in-flight meal service carts, provided by the flight kitchen distribution center, to the airport facility or directly to the aircraft. The transporter also takes the in-flight meal service carts back to the kitchen distribution center from the airport facility or from the aircraft.

The present invention also provides a plurality of thermal insulation containers storing goods with same temperatures or different temperatures. The transporter delivers the thermal insulation containers, provided by the flight kitchen distribution center, to the airport facility or directly to the aircraft. The transporter also takes the thermal insulation containers back to the kitchen distribution center from the airport facility or from the aircraft.

The flight kitchen distribution center is provided with a freezer, in-flight meal service carts and/or thermal insulation containers, and cold plates with different temperature ranges.

The thermal insulation container includes a storage space and contains a reusable cold plate/or hot plate, so as to maintain the required temperature of the stored food or goods during delivery.

To make it easy to manage the in-flight meal service cart or the thermal insulation container, every single in-flight meal service cart or the thermal insulation container is provided with a wireless ID tag, such as RFID, to track the goods during delivery, and to further track the temperature of the goods through the wireless ID tag.

The tracking of the in-flight meal service cart or the thermal insulation container is made possible by setting up a computer and a reader at one point of the transport system, such as the flight kitchen distribution center, so as to put the number and the location of the in-flight meal service carts or the thermal insulation containers under control. Through the reader that reads the information contained in the ID tag on the in-flight meal service cart, the computer in every flight kitchen distribution center is able to upload the information to the management center in a continuous and real-time manner. The management center is able to demand different flight kitchen distribution centers to adjust the number of the in-flight meal service carts or the thermal insulation containers following the acquisition of the required information through the flight kitchen distribution center allowed to access such information. Thanks to the request, flight kitchen distribution centers can make prompt adjustment of the number of the in-flight meal service carts or the thermal insulation containers, so that reasonable distribution of resources can be achieved. Through the system, each of the flight kitchen distribution centers is able to obtain correct information about the number and other information of the in-flight meal service carts or the thermal insulation contains at any time.

The wireless ID tag can also be a wireless sensor ID tag for temperature sensing and recording. In addition to containing the ID of the in-flight meal service cart or the thermal insulation container, the tag also takes the current temperature of the in-flight meal service cart on a regular basis according to the set time-interval, and saves the information, along with the time stamp, in the memory inside the electronic tag. The sensor RFID tag will transmit the values recorded in the memory (such as several sets of temperatures and time stamps) to the reader upon receiving the signal from the reader requesting for the reading of the information. Then, the reader will upload the information to the management center for the registration and tracking of the temperature of the in-flight meal service cart or the thermal insulation container during delivery.

The air-ground transport method for delivering multi-temperature goods according to the present invention includes:

providing an in-flight meal service cart for containing the prepared food, so as to complete a tallying and packing process;
providing a cold plate to be placed in the in-flight meal service cart to be loaded on a transporter and delivered to an airport facility, so as to complete an assembling and transporting process;
delivering the in-flight meal service cart to an aircraft directly through the transporter or through a conveyer, so as to complete an assembling and stand-by process;
providing the meal-serving devices to the passengers, so as to complete a serving and dinning process and proceed to an empty container stand-by process;
retrieving the meal-serving devices and putting them back to the in-flight meal service cart, so as to complete an empty container transporting process; and
delivering the in-flight meal service cart to the transporter to be transported to a flight kitchen distribution center for cleaning, so as to complete an empty container reuse process.

To ensure a full understanding of the purposes, the structural features, and the functions of the present invention, details will be described in the embodiment section by reference to the drawings.

### BRIEF DESCRIPTION OF THE DRAWINGS

FIG. 1 shows a schematic view of a centralized refrigeration system provided in a convention airplane.

FIG. 2A shows a schematic view of an air-ground transport system for delivering multi-temperature goods according to the present invention.

FIG. 2B shows a schematic view of a flight kitchen distribution center involved in the air-ground transport system for delivering multi-temperature goods according to the present invention.

FIG. 2C shows a schematic view of a thermal insulation container involved in the air-ground transport system for delivering multi-temperature goods according to the present invention.

FIG. 3 shows a flow chart of the operation of the air-ground transport system for delivering multi-temperature goods according to the present invention.

FIG. 4 shows a schematic view of another embodiment of the air-ground transport system for delivering multi-temperature goods according to the present invention.

FIG. 5 shows a schematic view of an in-flight meal service cart involved in the air-ground transport system for delivering multi-temperature goods according to the present invention.

FIG. 6 shows a schematic sectional view of the housing wall of the in-flight meal service cart involved in the air-ground transport system for delivering multi-temperature goods according to the present invention.

FIG. 7 shows a schematic view of a guiding plate disposed inside the in-flight meal service cart involved in the air-ground transport system for delivering multi-temperature goods according to the present invention.

FIG. 8 shows a schematic sectional view of the location of the guiding plate disposed inside the in-flight meal service cart involved in the air-ground transport system for delivering multi-temperature goods according to the present invention.

FIG. 9A shows a schematic view of the disposition of two cold plates involved in the air-ground transport system for delivering multi-temperature goods according to the present invention.

FIG. 9B shows a schematic view of the disposition of one cold plate involved in the air-ground transport system for delivering multi-temperature goods according to the present invention.

FIG. 10 is a schematic view of a transporter involved in the air-ground transport system for delivering multi-temperature goods according to the present invention.

FIG. 11A is a schematic view of a freezer involved in the air-ground transport system for delivering multi-temperature goods according to the present invention.

FIG. 11B is a schematic view of a cold plate involved in the air-ground transport system for delivering multi-temperature goods according to the present invention.

FIG. 12 is a schematic view of the way the cold plate is utilized in the air-ground transport system for delivering multi-temperature goods according to the present invention.

FIG. 13 shows a schematic view of an electronic tag reading system involved in the air-ground transport system for delivering multi-temperature goods according to the present invention.

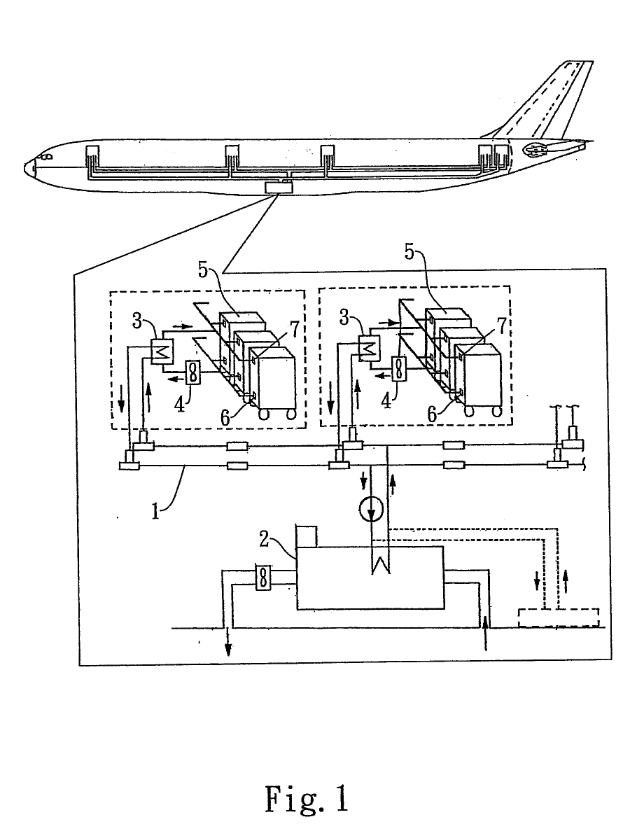

### DETAILED DESCRIPTION OF THE EMBODIMENTS

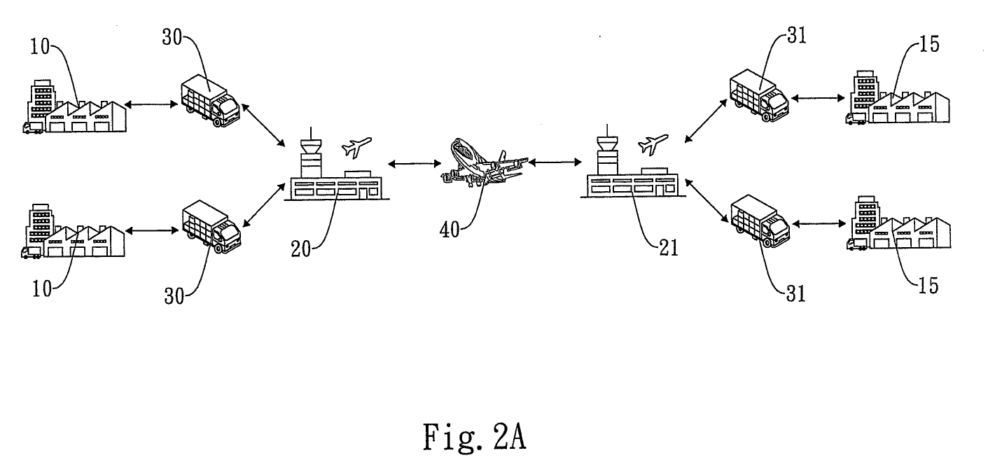

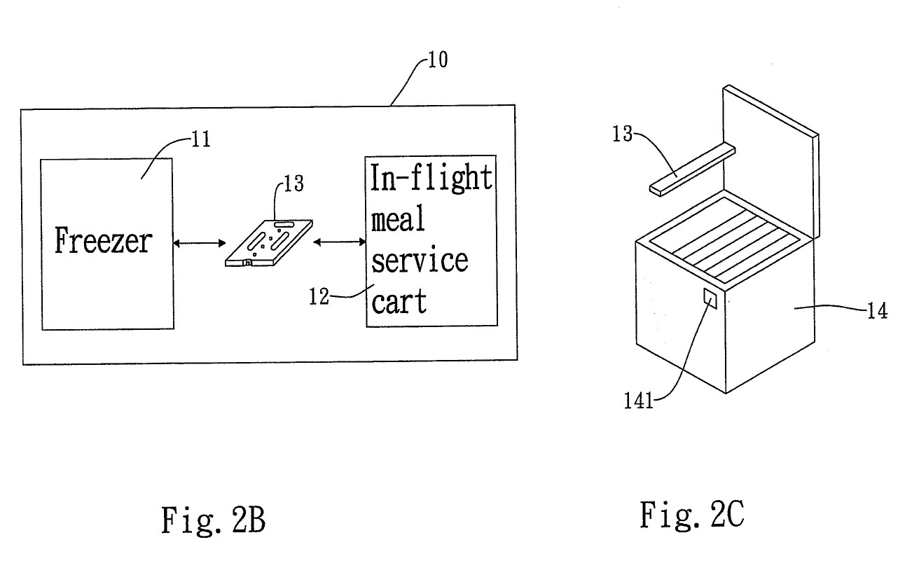

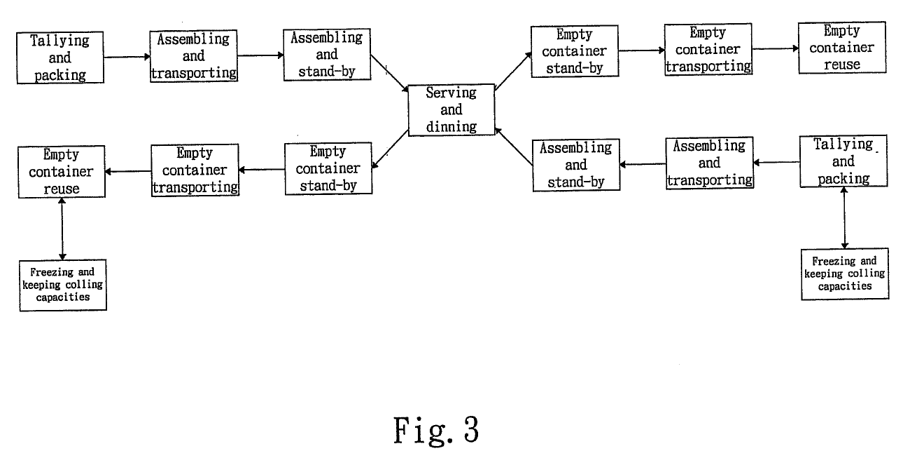

FIGS. 2A, 2B, and 2C respectively show a schematic view of an air-ground transport system for delivering multi-temperature goods according to the present invention, a schematic view of a flight kitchen distribution center, and a schematic view of a thermal insulation container. The air-ground transport system for delivering multi-temperature goods, as disclosed in the present invention, is to ensure the quality and sanitation of the food and to transport goods with multi-temperature requirements in a single attempt without refrigeration power. The present invention is particularly good at dealing with multi-temperature goods, such as foods with different temperatures. Not only can the present invention overcome concerns about refrigerating equipments and fuel consumption in relation to the conveyer and the aircraft, but it can also reduce the amount of dry ice required, preventing the dry ice from gasifying and from the subsequent air pollution and danger.

The air-ground transport system for delivering multi-temperature goods according to the present invention includes a flight kitchen distribution center 10, an airport facility 20, a transporter 30, and an aircraft 40. The flight kitchen distribution center 10 is where food is prepared, including a freezer 11, one in-flight meal service cart 12, and at least one cold plate 13, so that the prepared food can be placed on a meal-serving device (not shown) to be stored inside the in-flight meal service cart 12 to complete the tallying and packing process. The cold plate 13 keeps its cooling capacity inside the freezer and, when reaching the desired temperature, is retrieved for use in the in-flight meal service cart 12. Food can be made as same-temperature or multi-temperature, depending on the situation, before proceeding to the assembling and transporting process, during which the in-flight meal service cart 12 ready with food inside is equipped with the cold plate 13 and loaded onto the transporter 30 (a transport vehicle) to be delivered to the airport facility 20 in preparation for the assembling and stand-by process. Next, either through direct delivery of the transporter or through the transfer of a conveyer (not shown) in the airport facility 20, such as a loading truck, the in-flight meal service cart 12 is delivered to the temporary food storage and preparation area in the aircraft 40, such as an airplane, to be secured, with the cold plate still providing cooling energy keeping fresh the food stored inside the in-flight meal service cart 12.

During the serving and dinning process after the aircraft 40 takes off, the flight attendants serve meals to the passengers through the in-flight meal service carts 12, and retrieve the dishes after dinning. Usually main course is only heated by microwave before serving, so it is particularly important for the main course to be stored inside a thermal insulation container 14 to be kept cold by the cold plate 13 until being heated in the temporary food storage and preparation area, ready to be placed on the meal-serving device for serving. When the passengers are dinning, the in-flight meal service cart 12 is under the empty container stand-by process, ready to receive the dishes again. After the passengers finish dinning, the flight attendants place the meal-serving devices back to the in-flight meal service cart 12. Because passengers do not always finish their meals, the cold plate 13 is still required to keep the leftovers cold, so that it will not subject to instant decay and smell under the empty container transporting process before cleaning. After the aircraft 40 lands, the in-flight meal service cart 12 will be delivered to another flight kitchen distribution center 15 for waste treatment, either through the transfer of the conveyer in the airport facility 21 or through the direct delivery of the transporter 31. The waste treatment process is undertaken to remove the leftovers inside the in-flight meal service cart 12 in preparation for the empty container reuse process. Namely, after cleaning, the in-flight meal service cart 12 is ready to store the prepared meals again, under the tallying and packing process. Meanwhile, the used cold plate 13 is put into the freezer 11 again to keep its cooling capacity until it reaches the desired temperature and is retrieved for use in the in-flight meal service cart 12 ready with food inside, followed by the repeat of the cycle through the assembling and transporting process, the assembling and stand-by process, the serving and dinning process, the empty container stand-by process, the empty container transporting process, and the empty container reuse process, etc. During the whole process, the cold plate 13 serves as a cooling energy supplier to keep the food fresh.

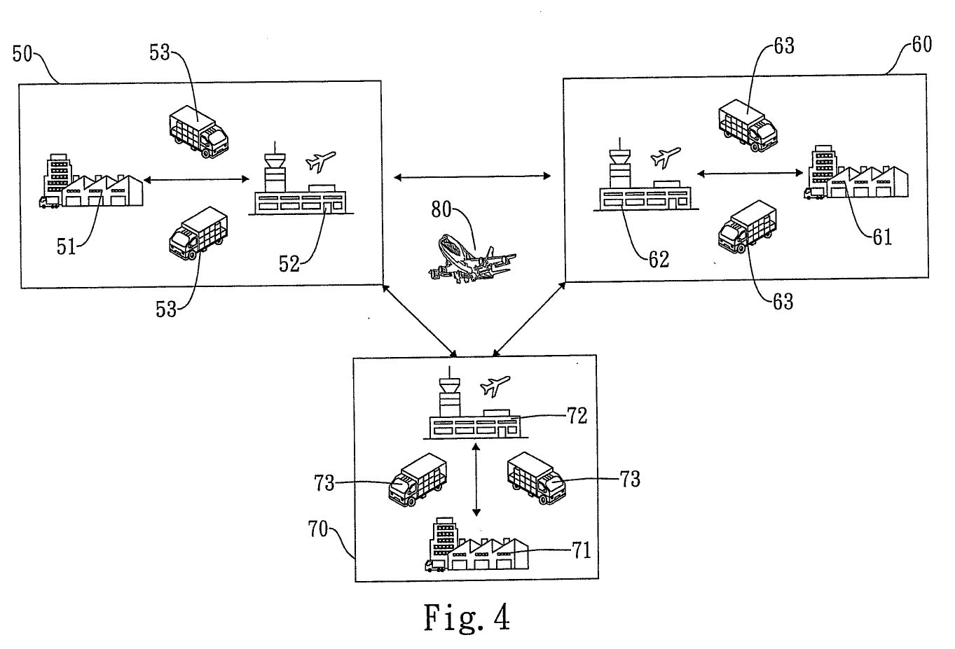

FIG. 4 shows a schematic view of another embodiment of the air-ground transport system for delivering multi-temperature goods according to the present invention. The air-ground transport system for delivering multi-temperature goods according to the present invention includes a first transport system 50, a second transport system 60, a third transport system 70, and an aircraft 80. The first transport system 50 includes a first flight kitchen distribution center 51, a first airport facility 52, and a first transporter 53, whereas the second transport system 60 includes a second flight kitchen distribution center 61, a second airport facility 62, and a second transporter 63, and the third transport system 70 includes a third flight kitchen distribution center 71, a third airport facility 72, and a third transporter 73. Passengers are transported among the first transport system 50, the second transport system 60, and the third transport system 70 through the aircraft 80. Each of the flight distribution centers 51, 61, 71 is provided with a freezer 11, in-flight meal service carts 12 and/or thermal insulation containers 14, and cold plates 13 with different temperature ranges (here, the present embodiment uses the same reference numbers for the same items described before). The flight kitchen distribution center 51, 61, 71 is where food is prepared before being placed on a meal-serving device for being stored inside the in-flight meal service cart 12 to complete the tallying and packing process. The functions of the first flight kitchen distribution center 51 include: (1) preparing food; (2) tallying and packing; (3) cleaning empty containers; (4) reusing empty containers; and (5) keeping the cooling capacities of the cold plates, etc. When being prepared, food can be made as same-temperature or multi-temperature, depending on the situation, before proceeding to the assembling and transporting process, during which the in-flight meal service cart 12 ready with food inside is equipped with a cold plate 13 and loaded onto a first transporter 53 (a transport vehicle) before being delivered to the first airport facility 52 in preparation for the assembling and stand-by process while retrieving the empty contains at the same time. The cold plate 13 keeps its cooling capacity inside the freezer and, when reaching the desired temperature, is retrieved for use in the in-flight meal service cart 12. A multi-temperature transporter 53 is utilized to deliver goods during the assembling and transporting process. The transporter 53 also serves to retrieve the empty containers and to transport them back on the return journey. Next, through a conveyer in the first airport facility 52, such as a loading truck, the in-flight meal service cart 12 is transferred to the temporary food storage and preparation area in the aircraft 80, such as an airplane, to be secured, with the cold plate still providing cooling energy keeping fresh the food stored inside the in-flight meal service cart 12 to complete the assembling and stand-by process. Alternatively, the in-flight meal service cart 12 can also be directly delivered to the temporary food storage and preparation area in the aircraft 80, such as an airplane, to be secured through the first transporter 53, which also carries back the empty containers from the aircraft.

During the serving and dinning process after the aircraft 80 takes off, the flight attendants serve meals to the passengers through the in-flight meal service carts 12, and retrieve the dishes after dinning. The preservation of tray meals should be a critical issue on a long-haul flight, during which several meals (usually 2-3 meals) are required. Usually main course is only heated by microwave before serving, so it is particularly important for the main course to be stored inside a thermal insulation container 14 to be kept cold by the cold plate 13 until being heated in the temporary food storage and preparation area, ready to be placed on the meal-serving device for serving. When the passengers are dinning, the in-flight meal service cart 12 is under the empty container stand-by process, ready to receive the dishes again. After the passengers finish dinning, the flight attendants place the meal-serving devices back to the in-flight meal service cart 12. Because passengers do not always finish their meals, the cold plate 13 is still required to keep the leftovers cold, so that it will not subject to instant decay and smell under the empty container transporting process before cleaning. After the aircraft 80 lands at the second airport facility 62, the in-flight meal service cart 12 will be delivered by the second transporter 63 to the second flight kitchen distribution center 61 for waste treatment after being transferred from the conveyer in the second airport facility 62. Alternatively, the in-flight meal service cart 12 can also be delivered to the second flight kitchen distribution center 61 directly through the second transporter 63. The waste treatment process is undertaken to remove the leftovers inside the in-flight meal service cart 12 in preparation for the empty container reuse process. Namely, after cleaning, the in-flight meal service cart 12 is ready to store the prepared meals again, under the tallying and packing process. Meanwhile, the used cold plate 13 is put into the freezer 11 again to keep its cooling capacity until it reaches the desired temperature and is retrieved for use in the in-flight meal service cart 12 ready with food inside, followed by the repeat of the cycle through the assembling and transporting process, the assembling and stand-by process, the serving and dinning process, the empty container stand-by process, the empty container transporting process, and the empty container reuse process, etc. to deliver the in-flight meal service cart from the second flight kitchen distribution center 61 to the third flight kitchen distribution center 71. Similarly, the in-flight meal service cart 12 is prepared in the third flight kitchen distribution center 71 to be delivered to the aircraft 80 to serve the passengers, followed by going over each of the processes in the lower end of the process cycle described above to deliver the in-flight meal service cart 12 to the first flight kitchen distribution center 51 to complete the transporting process among airports. In the whole transporting process among the flight kitchen distribution centers 51, 61, 71, the clod plate 13, by alternating between keeping and losing its cooling capacity, releases cold and keeps the desired temperature in compliance with the requirement of the in-flight meal service cart 12, so that the freshness of the food can be kept and the leftovers of the in-flight meals will not subject to instant decay. Moreover, each of the flight kitchen distribution centers 51, 61, 71 can be used to prepare food, to tally and pack, to clean empty containers, to reuse empty containers, and to keep the cooling capacities of the cold plates, etc.

The present invention also allows preservation of foods with all temperature requirements, as shown in the following table:

| DETAILED | TEMPERATURE | RELATED | SIMPLIFIED |
|---|---|---|---|
| CLASSIFICATION | REQUIREMENT | PRODUCTS | CLASSIFICATION |
| Fresh (food) | at a constant 18° C. | box lunches, | fresh |
| products | | sandwiches, rice | |
| | | balls, cool noodles, | |
| | | and chocolate, etc. | |
| Cold products | 0° C.~+7° C. | fresh vegetables | cold |
| | | (leaf vegetables, | |
| | | fresh cut | |
| | | vegetables), fruit | |
| | | juice, milk, milk | |
| | | drink, daily food | |
| | | (tofu, dairy | |
| | | products), processed | |
| | | meat (sausage, ham), | |
| | | flowers, etc. | |
| Chilled products | −2° C.~+2° C. | livestock products | |
| | | (beef, pork, lamb), | |
| | | poultry meat | |
| | | (chicken, duck), | |
| | | seafood (fish, | |
| | | shellfish), finely | |
| | | crushed ice, etc. | |
| Frozen products and | below −18° C. | frozen vegetables, | frozen |
| iced products | | frozen prepared food | |
| | | (dumplings, steamed | |
| | | buns with stuffing, | |
| | | pizza), ice cream, | |
| | | etc. | |
| Cryogenic products | below −30° C. | sashimi | |

Goods with various temperature requirements include hot food (above 60° C.), room temperature food (normal temperature), fresh food products (at a constant 18° C.), refrigerated products (0° C.˜+7° C.), chilled products (−2° C.˜2° C.), frozen products and iced products (below −18° C.), ultra-low-temperature products (below −30° C.), and their arbitrary combinations. Since the in-flight meal service cart and the thermal insulation container according to the present invention are configured, respectively, to keep fresh food and cooked meals, they are able to transport food with different temperature requirements.

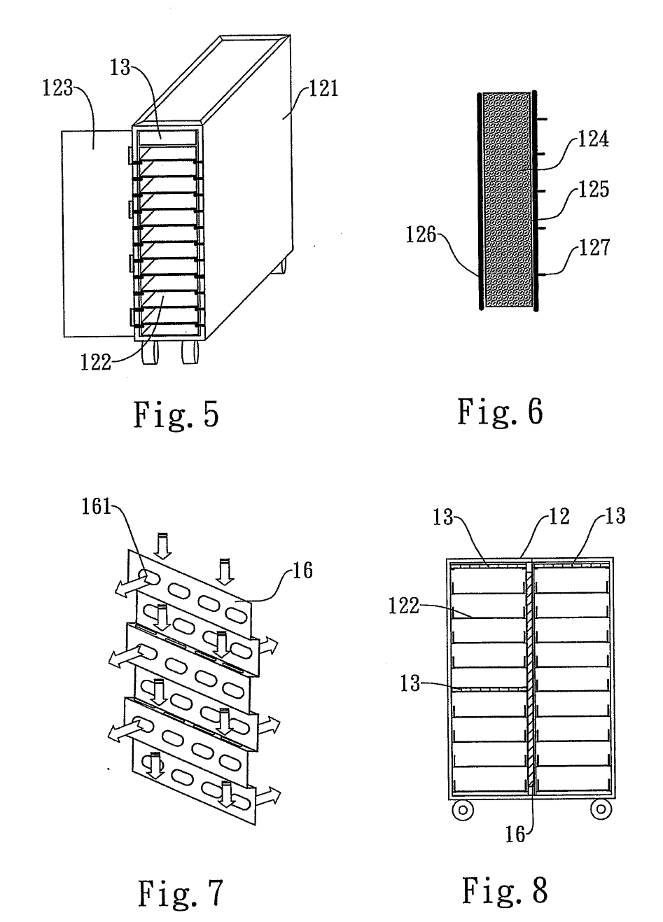

FIG. 5 and FIG. 6 respectively show a schematic view of an in-flight meal service cart and a schematic sectional view of the housing wall of the in-flight meal service cart, according to the present invention of an air-ground transport system for delivering multi-temperature goods. The in-flight meal service cart 12 includes a rectangular housing 121, a cold plate 13, a plurality of meal-serving devices 122, and an access panel 123 pivotably connected to one side of the housing 121 opening for swinging. The cold plate 13 is placed on the upper level of the rectangular housing 121, supplying cooling energy to the multiple meal-serving devices 122, such as meal trays and their accompanying food, whereas the access panel 123 is used to open/close the access door with the meal-serving devices 122 being stowed inside the in-flight meal service cart 12. The rectangular housing 121 is made of a thermal insulation material 124, such as a vacuum insulated panel or a foam material. The thermal insulation material 124 is contained between the inner panel 125 and the outer panel 126 by molding. The inner panel 125 and the outer panel 126 are made of an aluminum alloy or plastic. The inner panel 125 is formed into tray supports 127 by aluminum alloy extrusion or by plastic molding, with the wall of the inner panel 125 being formed into a plurality of tray supports by monolithic molding for supporting the meal-serving devices.

FIG. 7 and FIG. 8 respectively show a schematic view of a guiding plate disposed inside the in-flight meal service cart and a schematic sectional view of the location of the guiding plate, according to the present invention of an air-ground transport system for delivering multi-temperature goods. When the meal trays are arranged in two columns, a guiding plate 16 can be disposed in between. There is a plurality of air vents 161 disposed on the guiding plate, which bends at a right angle in a continuous manner. Since the guiding plate 16 bends at a right-angle with air vents disposed on each of the plate's panels, it is easy for the cold air to travel to the bottom or to the front directly through the air vents 161, as shown in FIG. 7. The guiding plate 16 enables air that is released by the cold plate 13 to be uniformly distributed, through the air vents 161, to the lower level of the cart, so as to maintain the temperature of the meals in the lower level. The present invention intends to use the guiding plate 16 to allow cold air to reach the bottom portion of the in-flight-meal service cart 12 through the air passage, so that a uniform temperature distribution inside the in-flight meal service cart 12 can be maintained.

As shown in FIG. 8, the guiding plate 16 is disposed between the two columns of meal-serving devices 122, so that cold air can move towards two sides. The guiding plate 16 can be disposed in the back (opposite the access panel) of the in-flight meal service cart 12 if the cart has only one column of meal-serving device 122, through which air can be guided to the bottom portion to keep the temperature and freshness of the food.

FIG. 9A and FIG. 9B respectively show a schematic view of the disposition of two cold plates and a schematic view of the disposition of one cold plate involved in the air-ground transport system for delivering multi-temperature goods according to the present invention. Two embodiments are disclosed concerning the in-flight meal service cart in the present invention. One embodiment is shown is FIG. 9A, where the two cold plates 13 are placed respectively in the upper portion and the middle portion of the in-flight meal service cart 12, so as to shorten the cold air travel distance and to extend the freshness of the food. Thin cold plates 13 are used to save room for the in-flight meal service cart 12 and are placed in layers. The other embodiment is shown in FIG. 9B, where the cold plate 13 is disposed in the upper portion of the in-flight meal service cart 12, under a swing cover plate (not shown) allowing easy access to replace the cold plate. A thick cold plate 13 is used to extend the freshness of the food and is placed alone in the upper portion of the in-flight meal service cart 12.

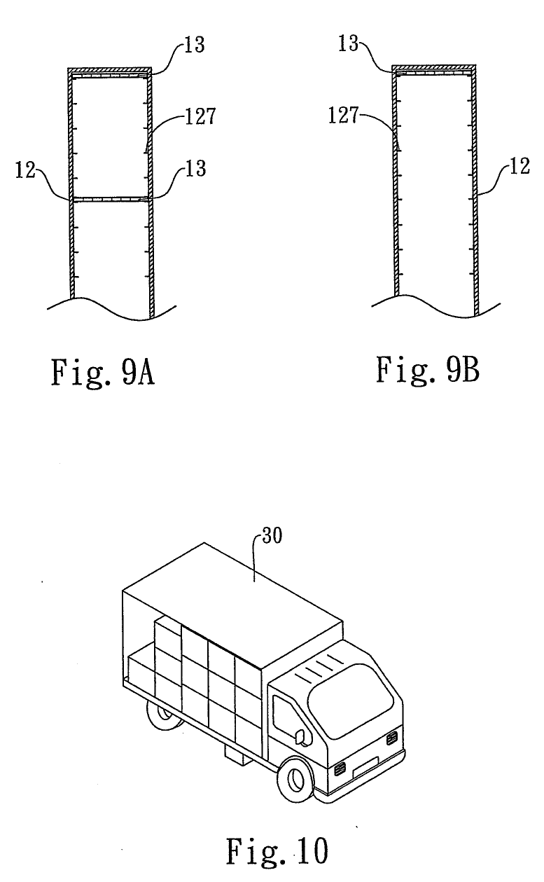

FIG. 10 shows a schematic view of a transporter involved in the air-ground transport system for delivering multi-temperature goods according to the present invention. The transporter 30 is a box truck designed to carry multi-temperature goods listed in the table above. The truck meets the requirement in carrying frozen food, refrigerated food, hot food, and room temperature food, especially in terms of food products. Accordingly, passengers' food or food products requiring thermal insulation can be delivered from the flight kitchen distribution center to the airport facility or directly to the aircraft through the transporter 30 while, at the same time, keeping the food or the food products fresh.

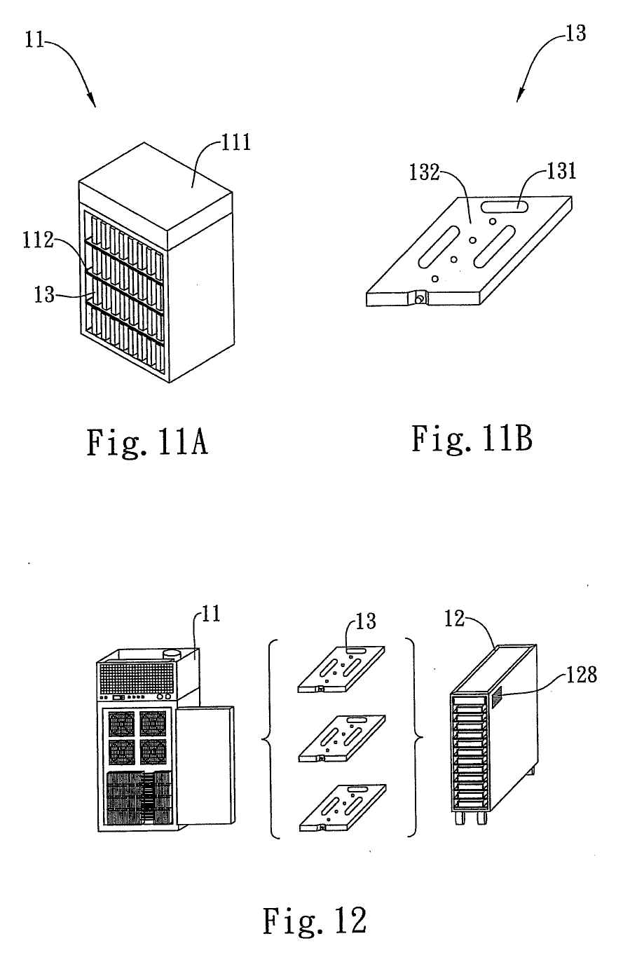

FIG. 11A and FIG. 11B respectively show a schematic view of a freezer and a schematic view of a cold plate involved in the air-ground transport system for delivering multi-temperature goods according to the present invention. As shown in FIG. 11A, the freezer is a cabinet 111 equipped with a refrigeration system, containing a plurality of stacking frames for holding the cold plates 13 to keep their cooling capacities. When different cooling capacities are required, a plurality of freezers 11 are provided to allow the cold plates 13 to keep the cooling energy under different temperatures. When high temperature is required for hot food products, a heater will be provided to allow the hot plate to keep its heating energy, so that hot food products with different temperature requirements can be kept fresh under desired temperatures.

As shown in FIG. 11B, the cold plate 13 has a plurality of through-holes 131 and includes a housing 132 filled with cooling liquid. In case of a hot plate, the hot plate has a plurality of through-holes and includes a housing filled with heating liquid.

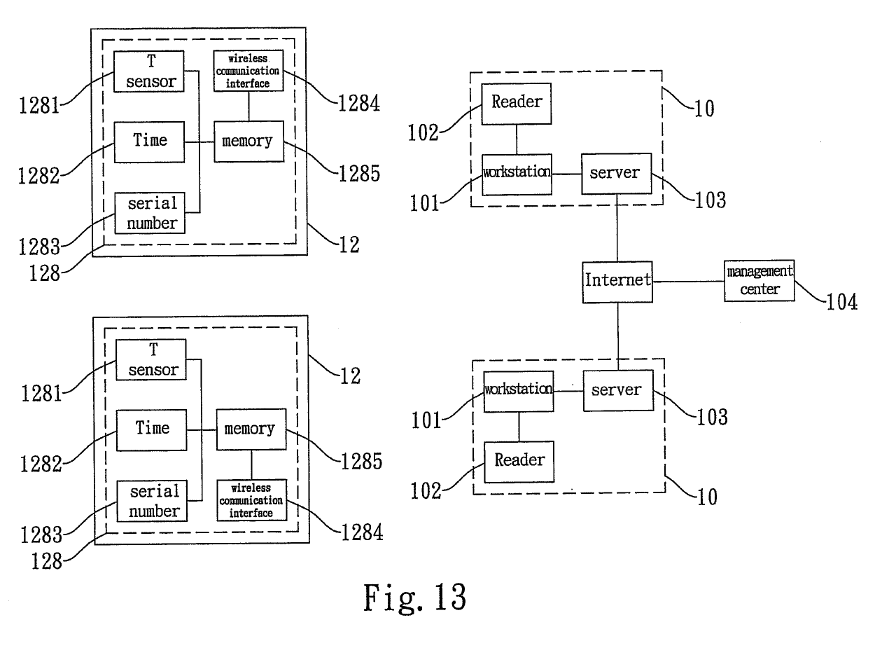

FIG. 12 shows a schematic view of the way the cold plate is utilized in the air-ground transport system for delivering multi-temperature goods according to the present invention. The cold plates 13 are shown to keep their cooling capacities inside freezers 11 with different temperatures, such as +5° C., −2° C., and −15° C., etc. The cold plate 13 is placed on the upper level of the in-flight meal service cart 12 after gaining the desired cooling energy through the freezer 11, so as to keep the freshness of the food in the lower level with the required temperature.

According to the air-ground transport system for the delivery of multi-temperature goods by reference to FIG. 12 and FIG. 13, every single in-flight meal service cart 12 or the thermal insulation container 14 is provided with a wireless ID tag 128, such as RFID, to make it easy to manage the in-flight meal service cart 12 or the thermal insulation container 14. The tracking of the in-flight meal service cart 12 is made possible by setting up a workstation 101 and a reader 102 at one point of the transport system, such as the flight kitchen distribution center 10, so as to put the number and the location of the in-flight meal service carts 12 or the thermal insulation containers 14 under control. Through the reader 102 that reads the information contained in the ID tag 128 on the in-flight meal service cart, the workstation 101 in every flight kitchen distribution center is able to transmit the information to the server 103, through which the information will be further uploaded to the management center 104 in a continuous and real-time manner. The ID tag 128 includes a temperature-sensing unit 1281, a time unit 1282, a basic information unit 1283, a wireless communication interface unit 1284, and a memory unit 1285. The temperature-sensing unit 1281 is designed to detect the real-time temperature of the in-flight meal service cart 12, and to transmit the signal of the sensed temperature to the memory unit 1285 to be saved. Each time-point when the temperature is taken is also recorded in the memory unit 1285 through the design of the time unit 1282. In addition, the basic information unit 1283 keeps the basic information, such as the serial number, of every single in-flight meal service cart 12, with the serial number also being presented as a bar code.

The flight kitchen distribution center 10 can access the information stored in the management center 104 whenever it needs information about the number and location of the in-flight meal service carts 12 or the thermal insulation containers 14 dispatched by other flight kitchen distribution centers 10. The management center 104 automatically updates real-time information obtained from worldwide flight kitchen distribution centers 10 and tells whether there is goods shortage or surplus according to the number of in-flight meal service carts 12 or thermal insulation containers 14 desired by every flight kitchen distribution centers 10. As a result, the flight kitchen distribution centers 10 can make prompt adjustment of the number of the in-flight meal service carts or the thermal insulation containers, so that reasonable distribution of resources can be achieved. Through the system, each of the flight kitchen distribution centers 10 is able to obtain correct information about the number and other information of the in-flight meal service carts 12 or the thermal insulation contains 14 at any time.

The wireless ID tag 128 is also a wireless sensor ID tag for temperature sensing and recording. In addition to containing the ID of the in-flight meal service cart 12 or the thermal insulation container 14, the tag 128 also takes the current temperature of the in-flight meal service cart 12 or the thermal insulation container 14 on a regular basis according to the set time-interval, and saves the information, along with the time stamp, in the memory unit 1285 inside the electronic tag 128. Upon the reading of the information contained in the tag 128 by the reader 102, the sensor RFID tag 128 will transmit the values recorded in its memory unit 1285 (such as several sets of temperatures and time stamps) to the workstation 101, through the contact between the communication interface unit 1284 and the reader 102, before uploading the recorded values to the management center 104, so as to register and track the temperature of the in-flight meal service cart 12 or the thermal insulation container 14 during delivery.

The air-ground transport system for delivering multi-temperature goods can transport meals and goods with multi-temperature requirements in a single attempt, and enable the in-flight meal service carts to keep food fresh without excessive airplane fuel consumption. Features of the present invention are listed as follows:
1. The present invention provides a light-weighted box container with a thermal insulation function by holding a vacuum insulated panel between the inner panel and the outer panel (made of plastic or aluminum alloy) of the in-flight meal service cart.
2. The present invention keeps food under desired temperatures all the way during the air-ground transport period by replacing dry ice and in-flight refrigeration systems with cold plates with various temperature ranges, so that the consumptive refrigerant or dry ice, as well as the onboard air chiller, are no longer required, resulting in a reduction of refrigerant costs and fuel consumption.
3. Cold air is able to travel to the bottom of the in-flight meal service cart to ensure a uniform temperature distribution within the in-flight meal service cart through the design of air passage inside the in-flight meal service cart.
4. The present invention helps reduce costs by providing reusable cold plates.
5. The present invention provides cold plates with various temperature ranges to accommodate food products that require different temperatures.

Several embodiments of the present invention have been disclosed in the examples. However, the examples should not be construed as a limitation on the actual applicable scope of the invention, and as such, all modifications and alterations without departing from the spirits of the invention and appended claims, including the other embodiments, shall remain within the protected scope and claims of the invention.

What is claimed is:

1. An air-ground transport system for delivering multi-temperature goods, comprising:
a flight kitchen distribution center having at least a freezer, at least one in-flight meal service cart for storing food, and at least one cold plate keeping its cooling capacity inside the freezer before retrieved, with the in-flight meal service cart containing at least one cold plate;
an airport facility having an aircraft with a temporary food storage and preparation area; and
a transporter delivering the in-flight meal service cart;
with the cold plate providing cooling energy, keeping fresh the food inside the in-flight meal service cart.

2. An air-ground transport system for delivering multi-temperature goods as claimed in claim 1, wherein the transporter delivers the in-flight meal service cart to the temporary food storage and preparation area in the aircraft.

3. An air-ground transport system for delivering multi-temperature goods as claimed in claim 1, wherein the airport facility further includes at least a conveyer for transferring the in-flight meal service cart loaded on the transporter to the temporary food storage and preparation area in the aircraft.

4. An air-ground transport system for delivering multi-temperature goods as claimed in claim 1, wherein the transporter is a multi-temperature truck.

5. An air-ground transport system for delivering multi-temperature goods as claimed in claim 1, further including at least a thermal insulation container for containing a cooked food.

6. An air-ground transport system for delivering multi-temperature goods as claimed in claim 1, wherein the in-flight meal service cart includes a rectangular housing, a cold plate, a plurality of meal-serving devices, and an access panel for opening/closing the access door, with the cold plate placed on the upper level of the rectangular housing for supplying cooling energy to the multiple meal-serving devices stowed inside the in-flight meal service cart.

7. An air-ground transport system for delivering multi-temperature goods as claimed in claim 6, wherein the housing includes a thermal insulation material, an inner panel, and an outer panel, with the thermal insulation material disposed between the inner panel and the outer panel.

8. An air-ground transport system for delivering multi-temperature goods as claimed in claim 7, wherein the thermal insulation material is a vacuum insulated panel or a foam material.

9. An air-ground transport system for delivering multi-temperature goods as claimed in claim 7, wherein the thermal insulation material is contained between the inner panel and the outer panel by molding.

10. An air-ground transport system for delivering multi-temperature goods as claimed in claim 7, wherein the wall of the inner panel is formed into a plurality of tray supports by monolithic molding for supporting the meal-serving devices.

11. An air-ground transport system for delivering multi-temperature goods as claimed in claim 1, wherein the in-flight meal service cart contains a guiding plate having a plurality of air vents and bending at a right angle in a continuous manner.

12. An air-ground transport system for delivering multi-temperature goods as claimed in claim 11, wherein the air vents are disposed on each panel, making it easy for cold air to travel to the bottom or to the front directly through the air vents

13. An air-ground transport system for delivering multi-temperature goods as claimed in claim 11, wherein the in-flight meal service cart contains two columns of meal-serving devices, and the guiding plate is disposed between the columns.

14. An air-ground transport system for delivering multi-temperature goods as claimed in claim 11, wherein the guiding plate is disposed in the back of the in-flight meal service cart.

15. An air-ground transport system for delivering multi-temperature goods as claimed in claim 1, wherein the freezer is a cabinet equipped with a refrigeration system, containing a plurality of stacking frames for holding the cold plates to keep their cooling capacities.

16. An air-ground transport system for delivering multi-temperature goods as claimed in claim 1, wherein the cold plate has a plurality of through-holes and includes a housing filled with cooling liquid.

17. An air-ground transport system for delivering multi-temperature goods as claimed in claim 5, wherein the thermal insulation container includes a storage space and contains a reusable cold plate/or hot plate.

18. An air-ground transport method for delivering multi-temperature goods, comprising:
providing an in-flight meal service cart for containing the prepared food, so as to complete a tallying and packing process;
providing a cold plate to be placed in the in-flight meal service cart to be loaded on a transporter and delivered to an airport facility, so as to complete an assembling and transporting process;
delivering the in-flight meal service cart to an aircraft, so as to complete an assembling and stand-by process;
providing the meal-serving devices to the passengers, so as to complete a serving and dinning process and proceed to an empty container stand-by process;
retrieving the meal-serving devices and putting them back to the in-flight meal service cart, so as to complete an empty container transporting process; and
delivering the in-flight meal service cart to the transporter to be transported to a flight kitchen distribution center for cleaning, so as to complete an empty container reuse process.

19. An air-ground transport method for delivering multi-temperature goods as claimed in claim 18, wherein the transporter delivers the in-flight meal service cart to the aircraft to complete the assembling and stand-by process.

20. An air-ground transport method for delivering multi-temperature goods as claimed in claim 18, wherein the in-flight meal service cart loaded on the transporter is transferred to the aircraft by a conveyer in the airport facility after the assembling and transporting process, so as to complete the assembling and stand-by process.

21. An air-ground transport method for delivering multi-temperature goods as claimed in claim 18, wherein the cold plate keeps its cooling capacity inside a freezer.

22. An air-ground transport method for delivering multi-temperature goods as claimed in claim 18, wherein the aircraft includes a temporary food storage and preparation area for keeping and securing the in-flight meal service cart.

23. An air-ground transport method for delivering multi-temperature goods as claimed in claim 18, further including a thermal insulation container containing a main course for being kept cold by the cold plate.

24. An air-ground transport method for delivering multi-temperature goods as claimed in claim 18, wherein the empty container reuse process is immediately followed by the tallying and packing process.

25. An air-ground transport method for delivering multi-temperature goods as claimed in claim 18, including repeating all the processes.

26. An air-ground transport method for delivering multi-temperature goods as claimed in claim 18, wherein the in-flight meal service cart includes a rectangular housing, a cold plate, a plurality of meal-serving devices, and an access panel for opening/closing the access door, with the cold plate placed on the upper level of the rectangular housing for supplying cooling energy to the multiple meal-serving devices stowed inside the in-flight meal service cart.

27. An air-ground transport method for delivering multi-temperature goods as claimed in claim 26, wherein the housing includes a thermal insulation material, an inner panel, and an outer panel, with the thermal insulation material disposed between the inner panel and the outer panel.

28. An air-ground transport method for delivering multi-temperature goods as claimed in claim 27, wherein the thermal insulation material is contained between the inner panel and the outer panel by molding.

29. An air-ground transport method for delivering multi-temperature goods as claimed in claim 27, wherein the wall of the inner panel is formed into a plurality of tray supports by monolithic molding for supporting the meal-serving devices.

30. An air-ground transport method for delivering multi-temperature goods as claimed in claim 27, wherein the inner panel is formed into a tray support by aluminum alloy extrusion or by plastic molding.

31. An air-ground transport method for delivering multi-temperature goods as claimed in claim 18, wherein the in-flight meal service cart contains a guiding plate having a plurality of air vents and bending at a right angle in a continuous manner.

32. An air-ground transport method for delivering multi-temperature goods as claimed in claim 31, wherein the air vents are disposed on each panel, making it easy for cold air to travel to the bottom or to the front directly through the air vents

33. An air-ground transport method for delivering multi-temperature goods as claimed in claim 21, wherein the freezer is a cabinet equipped with a refrigeration system, containing a plurality of stacking frames for holding the cold plates to keep their cooling capacities.

34. An air-ground transport method for delivering multi-temperature goods as claimed in claim 23, wherein the thermal insulation container includes a storage space and contains a reusable cold plate/or hot plate.

35. An in-flight meal service cart, comprising:
a rectangular housing, a cold plate, a plurality of meal-serving devices, and an access panel for opening/closing the access door, with the cold plate placed on the upper level of the rectangular housing for supplying cooling energy to the multiple meal-serving devices stowed inside the in-flight meal service cart.

36. An in-flight meal service cart as claimed in claim 35 wherein the housing includes a thermal insulation material, an inner panel, and an outer panel, with the thermal insulation material disposed between the inner panel and the outer panel.

37. An in-flight meal service cart as claimed in claim 36, wherein the thermal insulation material is contained between the inner panel and the outer panel by molding.

38. An in-flight meal service cart as claimed in claim 36, wherein the wall of the inner panel is formed into a plurality of tray supports by monolithic molding for supporting the meal-serving devices.

39. An in-flight meal service cart as claimed in claim 36, wherein the inner panel is formed into a tray support by aluminum alloy extrusion or by plastic molding.

40. An in-flight meal service cart as claimed in claim 35, further containing a guiding plate having a plurality of air vents and bending at a right angle in a continuous manner.

41. An in-flight meal service cart as claimed in claim 40, wherein the air vents are disposed on each panel, making it easy for cold air to travel to the bottom or to the front directly through the air vents
